(19) United States
(12) Patent Application Publication
(10) Pub. No.: US 2022/0382301 A1
(43) Pub. Date: Dec. 1, 2022

(54) FLOW CONTROL BY SUPERPOSITION OF INTEGRATED NON-LINEAR VALVES

(71) Applicant: Danmarks Tekniske Universitet, Kgs. Lyngby (DK)

(72) Inventors: Kaare Hartvig Jensen, Birkerød (DK); Keunhwan Park, Søborg (DK)

(21) Appl. No.: 17/762,795

(22) PCT Filed: Sep. 25, 2020
(86) PCT No.: PCT/EP2020/076980

§ 371 Date: Mar. 23, 2022

(30) Foreign Application Priority Data
Sep. 27, 2019 (EP) 19200144.4

(51) Int. Cl. G05D 7/01; G06F 30/28

(52) U.S. Cl. CPC G05D 7/012; G06F 30/28; G06F 2111/04

(57) ABSTRACT

A valve assembly using at least two pressure-sensitive leaky check valves has a non-linear flow-rate versus pressure-drop relation. A method for optimizing such a valve assembly is capable of determining a minimum required number of such valves and outputting the material parameters of each valve. The valve assembly and method allows for arbitrary flow control, which has numerous applications such as within drug delivery, food processing, and industrial flow control. The valve assembly is completely passive, i.e. there is no need for a feedback network. The flow control is achieved using only fluid-structure interactions.

### CROSS-REFERENCE TO RELATED APPLICATIONS

This application is the U.S. National Stage of PCT/EP2020/076980 filed on Sep. 25, 2020, which claims priority to European Patent Application 19200144.4 filed on Sep. 27, 2019, the entire content of both are incorporated herein by reference in their entirety.

### FIELD OF THE INVENTION

The present disclosure relates to a valve assembly comprising at least two pressure-sensitive passive check valves, wherein the valve assembly is capable of approximating a given objective flow-rate versus pressure-drop characteristic. The disclosure further relates to a computer-implemented method for optimizing and/or customizing said valve assembly.

### BACKGROUND OF THE INVENTION

Flow control systems are used within a wide range of applications such as within drug delivery and diagnostics, food processing, and industrial flow control.

Conventional flow control techniques rely on computerized valves and pumps that modify the flow in feed pipes or the input pressure in real time. This is typically achieved using a negative feedback loop comprising a flow sensor and a processor. Such a configuration is often complex and expensive. Moreover, these conventional flow control systems are often limited to a constant flow.

Therefore, there is a need to obtain a passive flow control system that obviates the need for expensive active components to regulate flow, thereby being more cost-effective. Furthermore, there is a need for a flow control system that can be easily customized/modified to fit a specific application.

### SUMMARY OF THE INVENTION

The present disclosure addresses the above-mentioned issues by providing a valve assembly that facilitates arbitrary flow control, and the disclosure further provides a computer-implemented method to customize/optimize said valve assembly. The arbitrary flow control is achieved by combining multiple passive check valves in a valve assembly, wherein each of the valves has a non-linear flow-rate versus pressure-drop relation. The flow-rate versus pressure-drop characteristic of the valve assembly is a superposition of the individual valve characteristics. The latter may be customized by choosing appropriate material parameters of each valve.

The presently disclosed method of customizing a valve assembly allows for arbitrary flow control, which has numerous applications, e.g. within the medical industry, the food industry, and the energy industry. The presently disclosed valve assembly can be tailor-made to fit a specific application, such that it provides a desired flow control specified by the customer. In other words, the customer may specify a desired flow-rate versus pressure-drop relation that the valve assembly should possess. This can be almost any imaginable characteristic, e.g. it could be a reverse form of Ohm's law applied to fluids, such that the flow rate drops for increasing pressures, or it could be a constant function, i.e. wherein the flow rate is independent of the applied pressure, or other non-linear functions. This is achieved by tuning the material parameters of a plurality of passive check valves arranged in a valve network.

The presently disclosed valve assembly has a number of advantages over existing technology. The main advantage is that conventional feedback networks comprising computerized pumps and valves can be avoided, thereby reducing the cost of flow control. In other words, the valve assembly is preferably completely passive, i.e. there is no need for electronic processors etc. Another advantage is that the individual valves may be manufactured so inexpensive that they can form a collection or reservoir of valves from which an engineer can select appropriate valves, and combine them in a network to achieve the desired flow control. Furthermore, the valves may provide a modular concept, wherein the valves can be easily combined and/or exchanged to form a valve assembly.

In one embodiment, the valves form separate components that may be joined, e.g. using liquid tubes, to form a valve assembly. This may allow the valves to be easily exchanged from the valve assembly, as explained above, in case the requirements for the flow control change. In another embodiment, the valves are integrated in a common membrane, such that they may be packed more closely together (cf. FIG. 10A). Thus, the valve assembly may be provided as a single unit comprising a housing with one fluid inlet and one fluid outlet, as shown in FIG. 10B. Thereby, the valves occupy a smaller space and furthermore the install or integration of the valve assembly in a larger fluid network is made more swift and effortless.

### BRIEF DESCRIPTION OF THE DRAWINGS

FIG. 1A shows an exploded view of an embodiment of a pressure-sensitive leaky check-valve according to the present disclosure;

FIG. 1B shows a schematic of the working principle of the check-valve according to the present disclosure. The arrows indicate the direction of a fluid flowing through the valve;

FIG. 1C shows a non-linear flow-rate versus pressure-drop characteristic of a valve according to the present disclosure. The grey dots are experimental data and the solid curve is a fit to the data;

FIG. 2A shows a schematic of a valve assembly comprising two leaky check-valves connected in parallel;

FIG. 2B shows the flow-rate versus pressure-drop relation for each valve and for the parallel valve assembly of FIG. 2A (here denoted a valves network);

FIG. 2C shows an example of the presently disclosed method, wherein a valve assembly was optimized in order to approximate an objective flow-rate versus pressure-drop characteristic;

FIG. 2D shows an example of the presently disclosed method, wherein a valve assembly was optimized in order to approximate an objective flow-rate versus pressure-drop characteristic;

FIG. 3 shows schematically an embodiment of the computer-implemented method to determine the optimal arrangement of non-linear valves to achieve arbitrary flow control;

FIG. 4 shows a 3D illustration of an embodiment of a non-linear check valve according to the present disclosure;

FIG. 5 shows a schematic diagram of the working principle of the device according to an embodiment of the present disclosure;

FIG. 6A shows the working principle of the valve according to the present disclosure. The figure illustrates the gradual closure of the valve for increasing pressures;

FIG. 6B shows some relevant design parameters of the leaky check-valve;

FIG. 6C shows experimental data of a pressure-sensitive leaky check-valve, wherein the flow-rate through the valve was recorded for various pressure drops;

FIG. 7 shows a schematic of a valve assembly comprising three check-valves according to one embodiment of the present disclosure. The three valves are connected in parallel;

FIG. 8A shows experimental data from a valve assembly mimicking an objective function;

FIG. 8B shows experimental data from a valve assembly mimicking another objective function, different from the function of FIG. 8A;

FIG. 9A shows two check valves according to an embodiment of the present disclosure;

FIG. 9B shows the base part of a valve comprising a membrane;

FIG. 9C shows the base part of a valve assembly according to an embodiment of the present disclosure. The valve assembly comprises three check valves as outlined with dashed curves;

FIG. 10A shows yet another embodiment of a valve assembly according to the present disclosure. This valve assembly comprises four leaky check-valves;

FIG. 10B shows a valve assembly that has been assembled with its base part and top part, such that the final valve assembly only features one fluid inlet and one fluid outlet;

FIG. 10C shows the inner parts of a valve assembly next to the housing of the valve assembly;

FIG. 11 shows valve assemblies of different configurations;

FIG. 12A shows the flow rate through versus applied pressure difference over a valve assembly comprising two pressure-sensitive passive check valves 1 and 5 connected in series;

FIG. 12B shows the flow rate through versus applied pressure difference over a valve assembly comprising three parallel pressure-sensitive passive check valves 1, 3, and 6;

FIG. 12C shows the flow rate through versus applied pressure difference over a valve assembly comprising three parallel pressure-sensitive passive check valves 1, 3, and 4;

FIG. 12D shows the flow rate through versus applied pressure difference over a valve assembly comprising three parallel pressure-sensitive passive check valves 1, 2, and 3; and

FIG. 13 shows the flow characteristics from a peristaltic pump versus time with (solid line) and without (dashed line) a valve assembly connected in series after the peristaltic pump.

### DEFINITIONS

The present disclosure is concerned with a valve with a number of properties—and the assembling of a plurality of such valves to form a valve assembly or a valve network. The valve is a pressure-sensitive leaky check-valve that has a non-linear flow-rate versus pressure-drop characteristic/relation. Since this is very cumbersome to write, sometimes the valve is referred to herein as a non-linear valve, a leaky valve, a check-valve, a shut-off valve, a passive valve, a hydraulic element, etc. It may also be referred to simply as a valve or a device.

Occasionally, the term pressure is used to refer to the pressure-drop across the valve. To the skilled person, however, it should be evident from the context when the pressure-drop is abbreviated to pressure.

In the present context, the terms “flow-rate versus pressure-drop characteristic” and “flow-rate versus pressure-drop characteristic” are used interchangeably. Sometimes, these are abbreviated to characteristic.

### DETAILED DESCRIPTION OF THE INVENTION

The present disclosure relates to a valve assembly comprising at least two pressure-sensitive passive check valves connected in series or parallel, such that the valve assembly mimics or approximates a given objective flow-rate versus pressure-drop characteristic. The disclosure further relates to a computer-implemented method for customizing said valve assembly in order to achieve the desired output flow-rate versus pressure-drop characteristic using a minimum number of valves.

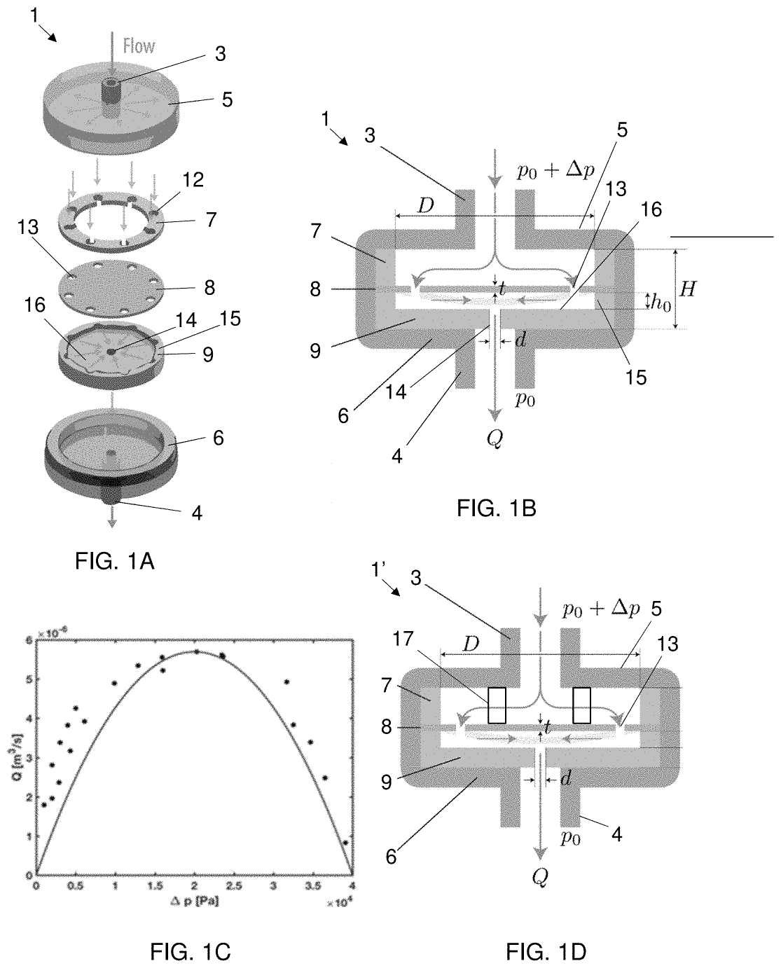

The valves used for the presently disclosed valve assembly are custom-made by the applicant. The valve itself is described in the following. The valve is a two-port valve, i.e. it has two openings: one for fluid to enter (the fluid inlet) and one for fluid to exit (the fluid outlet). Preferably, it is a leaky check valve, which is used in the ‘wrong’ direction. In general, check valves refer to valves that ideally only allows fluid to flow through the valve in one direction. Thus, a check-valve forbid fluid flow completely in one direction, i.e. the flow-rate is ideally zero for negative pressure drops. In its normal working regime, i.e. for positive pressure values, the flow-rate typically increases linearly with the applied pressure. However, check-valves may display non-zero flow rates for small negative values of applied pressure. In that case, they are known as leaky check-valves. The presently disclosed check-valve is designed to work in that regime of (negative) pressures. This corresponds to using the check-valve in the wrong direction. Furthermore, the flow-rate versus pressure-drop relation is non-linear in this regime (cf. FIG. 1C), which the applicant has discovered may be exploited to achieve arbitrary flow control by combining several of such non-linear check-valves in a valve assembly.

The valve is preferably purely mechanical and may be manufactured using inexpensive manufacturing techniques such as 3D printing. Thus, the flow control is preferably achieved solely from fluid-structure interactions inside the valve. Furthermore, preferably it is a passive valve meaning that there is no need for a feedback network, which is often expensive. The passive behaviour of the valve also implies that once the valve is manufactured, its characteristics (i.e. the flow-rate versus pressure-drop relation) is predetermined, i.e. a user cannot modify the relation between applied pressure and flow-rate through the device. The valve is intended as a building block or a component in a network of valves. Thus, optimally the valve may be manufactured so inexpensive that the user can possess a collection of valves for use in an assembly, analogous to an electronics engineer combining a plurality of cheap electrical resistors to form a network of resistors with a combined resistance. The valve assembly may therefore be characterised as modular, in that it comprises a number of modules (valves) that can be combined in various ways. The valve assembly itself may also be used in combination with known hydraulic components such as other valves, e.g. a cracking valve such that the valve assembly opens at a higher pressure.

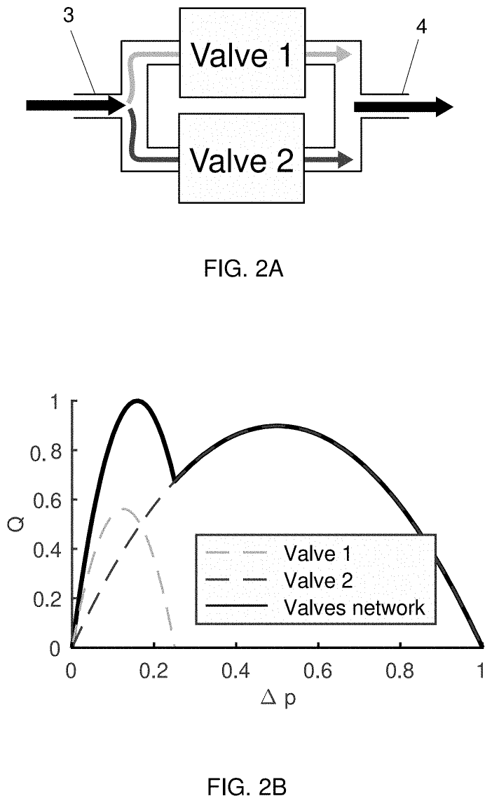

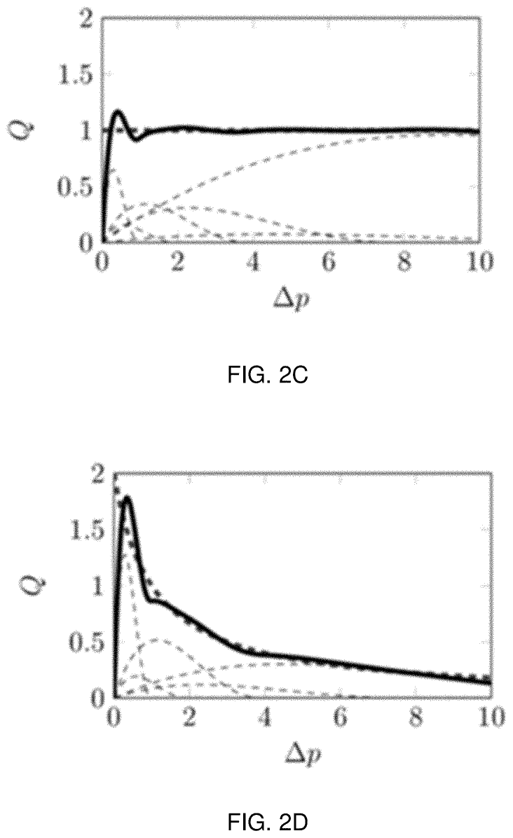

Furthermore, there are many applications wherein it is an advantage that the valve assembly has a fixed and predetermined relationship between pressure and flow rate. For instance, dialysis apparatuses often require a constant flow rate independent of the applied pressure. The presently disclosed valve assembly is able to approximate such a constant flow rate (cf. FIG. 2C) by using only four valves. In case more valves are used, an even better approximation may be achieved. Hence, the valve assembly constitutes a foolproof and easy-to-use flow regulator in that the assembly is not able to deviate from the predetermined characteristic. Another example of an application that typically benefits from a constant flow rate independent of pressure is a soap dispenser.

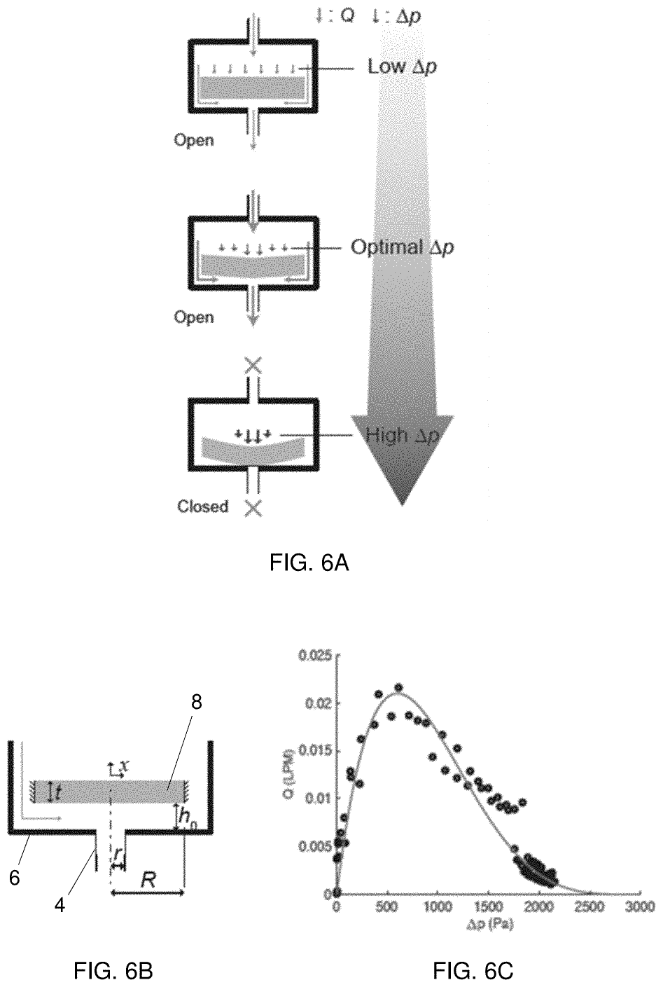

The passive leaky check-valve comprises an inlet channel, also referred to as a fluid channel, a flexible element, a bypass channel or one or more openings, a small channel, and a fluid outlet. The working principle is illustrated in FIG. 5, which shows a cross-section of a valve according to one embodiment of the present disclosure. The direction of the flow is indicated by arrows. The flow rate is controlled by the degree of membrane deflection, which in turn is controlled by the pressure-drop across the valve. At zero pressure, the flow rate is also zero. Once a pressure is applied, the membrane deflects downwards and as a result, the height of the small channel located beneath the membrane is reduced. At some predetermined pressure, the flow rate is maximum, i.e. the membrane is not yet contacting the lower wall of the small channel. As the pressure is further increased, the flow-rate decreases and eventually the membrane touches the wall such that the fluid outlet is closed and the fluid flow stops. Thus, the valve preferably displays a gradual closure of the valve for increasing pressures. This gradual closure is illustrated in FIG. 6A. Furthermore, this behaviour of the valve is confirmed by an experiment conducted by the applicant, the results of which can be seen in FIG. 1C.

The resulting flow rate versus pressure-drop characteristic of a single valve depends on a number of parameters related to the geometry and the material of the valve. Important parameters dictating said characteristic of the device include the size of the flexible element (e.g. the surface area a membrane), the thickness of the membrane, the material of the flexible element, the cross-sectional area of each channel (inlet channel, bypass channel, outlet channel, etc.), and the height of the channel underneath the flexible element. Only the flexible element is designed to deflect upon an applied pressure; thus, the flexible element is preferably made flexible in the range of desired working pressures. The working pressure of the valve assembly is preferably on the range from approximately 0.1 bar to approximately 10 bar. All other components of the device, e.g. the walls and the housing of the device, are preferably made of a rigid material. The valve assembly may be manufactured using microfluidic fabrication techniques known in the prior art such that the valve assembly constitutes a microfluidic valve assembly.

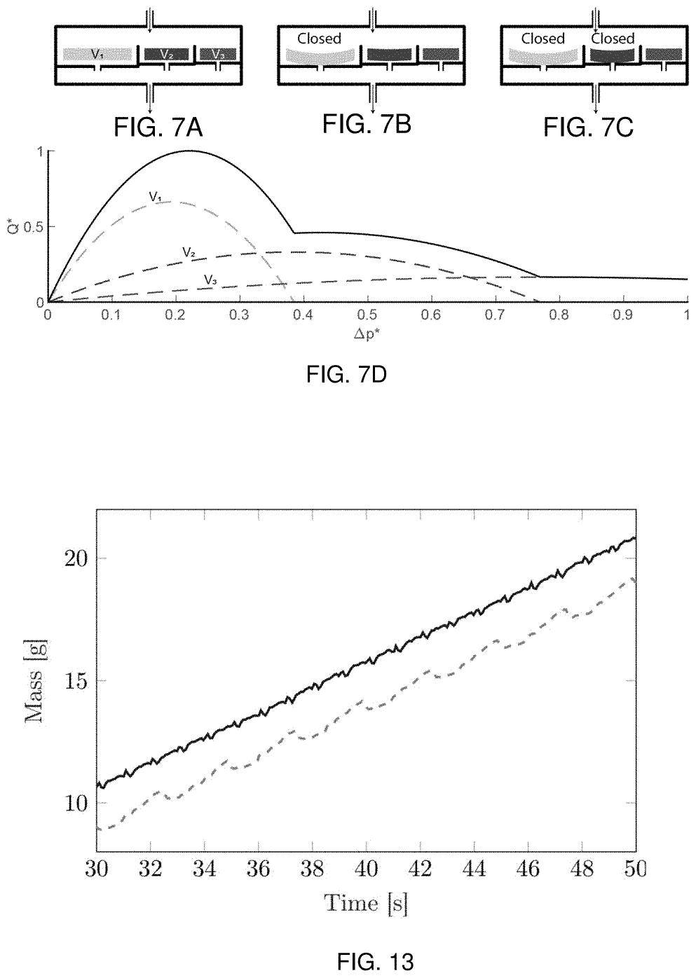

Accordingly, the flow rate versus pressure-drop characteristic of a single valve may be designed/tuned by choosing appropriate values for the above-mentioned parameters. In other words, the characteristic of the valve may be pre-selected. In general, the valve will display a peak flow-rate at a pre-determined pressure-drop. However, this peak may occur at various pressures depending on the chosen material parameters. For instance, a thick membrane is more difficult to bend than a thin membrane, and therefore the peak flow-rate may occur at a higher pressure for a valve comprising a thick membrane than that of a thin membrane. In addition, both the width and the height of the peak may be tuned by changing the values of the parameters. Similarly, the pressure at which the valve closes or shuts off may be pre-determined by choosing appropriate values of the material parameters of the valve. So each of the check valves of the valve assembly can close at a pre-determined pressure, which can be the same pressure or different pressures for the check valves. FIG. 2C-2D show various valve characteristics that are obtained by designing valves with different material parameters. The ability to determine the shut-off pressure or closing pressure is further illustrated in FIG. 7.

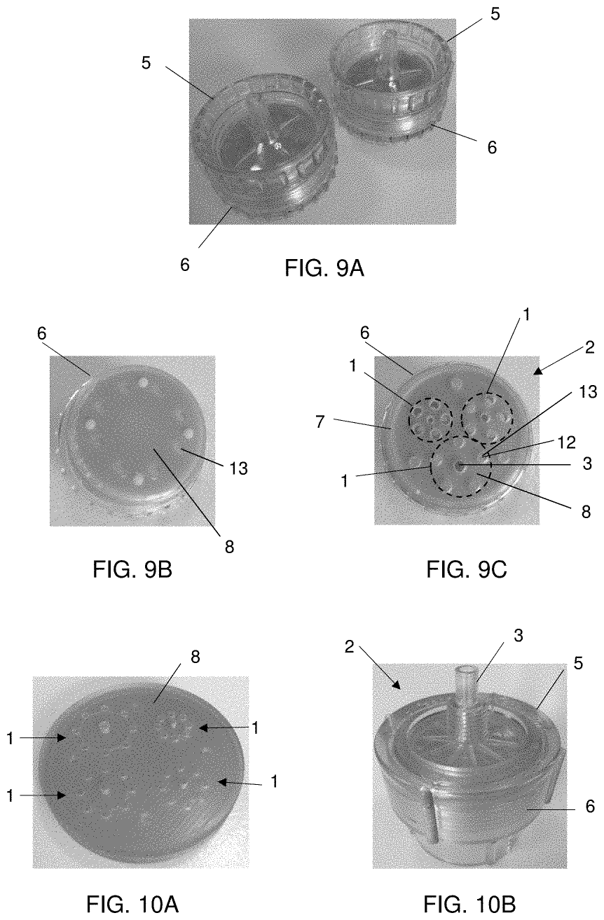

The valves may be assembled in a network to form a valve assembly (cf. FIG. 2A and FIG. 9C). They may be combined in series or parallel depending on the application and the desired output characteristic. FIG. 2A shows two valves combined in parallel. While the pressure-drop across each valve is equal, the pressure may cause a different flow-rate through each valve. The combined flow-rate versus pressure-drop relation may then be seen as a superposition of each valve characteristic. This is exemplified in FIG. 2B, which displays the flow-rate versus pressure-drop relation for each valve (dashed lines) and the relation of the valve network comprising the two valves (solid line). A similar example is shown in FIG. 7, which displays the characteristic of a valve assembly comprising three valves. It is seen that the resulting output flow-rate characteristic of the valve network differs from the characteristic of the individual valves. Thus, it is possible with the presently disclosed valve to form a valve assembly that shows a completely new flow-rate characteristic.

It is clear that the valve network using two valves is primarily intended as proof-of-concept, since it is the most simple example of a valve assembly featuring a characteristic that is a superposition of multiple valves. However, by assembling more than two valves in a network, wherein the valves preferably have different valve characteristics (i.e. by having different material parameters), the options for combining the valves and thereby the options for controlling the fluid flow increase tremendously. This is exemplified in FIGS. 2C and 2D, wherein four valves are combined in a valve network. Herein, an objective (theoretical) flow-rate/pressure-drop relation is given. The purpose of the valve network is to generate an output flow-rate/pressure-drop that approximates the objective relation as well as possible using a minimum number of valves (here exemplified using four valves). In other words, the presently disclosed valve assembly is capable of mimicking an objective flow-rate versus pressure-drop characteristic, thus facilitating essentially arbitrary flow control. The individual valves are tailor-made to the specific need, i.e. to achieve the desired characteristic of the valve network. Accordingly, the valve assembly is capable of providing a given objective flow-rate versus pressure-drop characteristic determined by the individual valve characteristics.

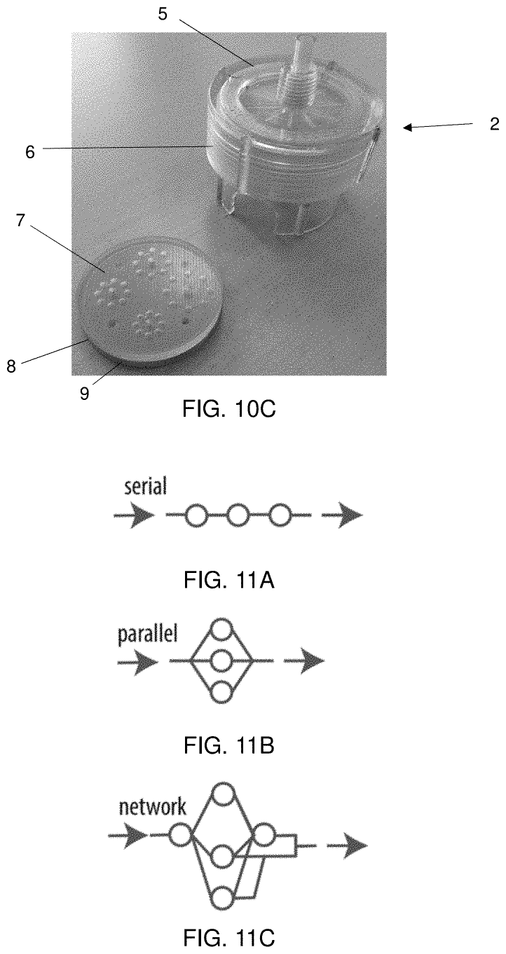

In another embodiment of the present disclosure, the valve assembly comprises multiple valves integrated in a single membrane, as seen on FIG. 9C, FIG. 10A, and FIG. 10C. Accordingly, this embodiment is an integrated valve assembly. By integrating multiple valves in the same membrane, the valves can be packed much closer, such that the final device is made smaller and easier to handle. Furthermore, tubes connecting the individual valves can be avoided, which means that less materials are used and that the final valve assembly is easier to handle and install. Since the valves share the same membrane, the ‘sub-membrane’ of each valve will have an identical thickness. However, by varying the size of the membrane and/or the gap, h₀, below the membrane and/or a diameter, d, of a hole in a pin-hole plate, the valve characteristics may be tuned as previously explained. In general, it is the rigidity of the flexible element, the gap below the flexible element and the area of the exit hole of the valve that determine the valve characteristic.

The present disclosure further relates to a computer-implemented method for designing or customizing a valve assembly as described above. The purpose of the method is to compute the material parameters of a pre-determined number of valves and how to combine them in order to achieve a given objective flow rate versus pressure-drop characteristic. Alternatively, the user may specify the given objective function accompanied with a maximum deviation from said function, and the method will then output the minimum number of valves required to approximate the objective function with the given precision and/or tolerance as well as the material parameters of each valve. The user may also provide the computer with a number of suggested valves with different valve characteristics. The method may then tune the characteristics of each valve to tune the characteristics of the valve network to mimic the objective function, and in that process it may also determine which valves are necessary. Hence, the number of necessary valves may be reduced by the method. The valve assembly may be customised/optimised using various different mathematical optimization methods. Typically, the optimization part of the algorithm serves the purpose of minimizing a function (e.g. the difference between the objective function and a ‘best guess’ function) subject to one or more constraints on an interval. Here, said constraints may be that the number of valves is fixed, that the tolerance (deviation from objective function) is fixed, or that the material parameters of the valve are fixed or other constraints.

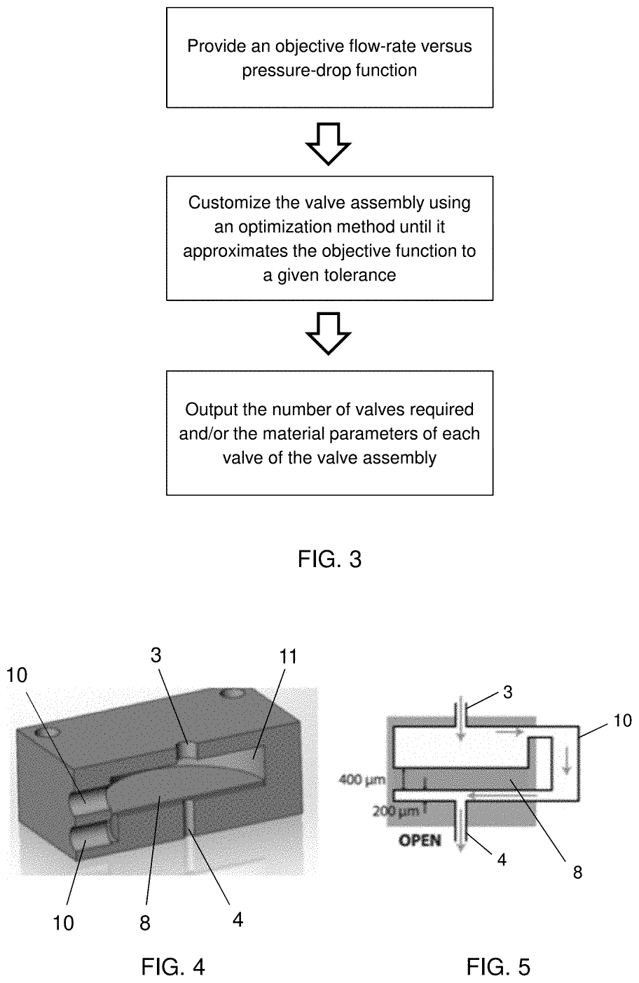

The computer-implemented method preferably begins with the step of providing an objective flow rate versus pressure-drop function. This function is preferably provided by a user and the function is usually specific for the given application. The second step of the method is preferably that the valve assembly is customized and/or optimized under a given constraint as explained above. The customization of the valve assembly is done by varying/tuning the material parameters of each valve until the valve network approximates the given objective function to a desired and pre-determined precision/tolerance. Formally, the optimization is typically done by minimizing the difference between the objective input function and an initial guess until the difference is accepted, i.e. until a given tolerance is reached. Finally, the method may output the minimum number of valves required, and/or the material parameters of each valve, and/or the deviation from the objective function. The computer-implemented method may utilize analytical formulas or it may use numerical methods, e.g. numerical minimization techniques. Finally, the valves may be fabricated according to the specifications and subsequently assembled in the specified network. One embodiment of the method is outlined in FIG. 3. Since the objective flow-rate versus pressure-drop relation may be chosen arbitrarily, the valve assembly facilitates arbitrary flow control within the operating range of the valves.

### DETAILED DESCRIPTION OF THE DRAWINGS

FIG. 1A shows a schematic of a pressure-sensitive leaky check-valve according to an embodiment of the presently disclosed valve. This embodiment comprises a top part 5 having a fluid inlet 3 configured for being connected to a pump (not shown), a spacer 7 with first openings 12, a membrane 8 with second openings 13, a pin-hole plate 9 with a hole 14, and a base part 6 having a fluid outlet 4. The elastic membrane can be circular and aligned at the centre of the pin-hole plate. The first openings of the spacer can be open radially inwards to receive the fluid flow from the fluid inlet 3 and guide the fluid down to and through the second openings down to the pin-hole plate. The spacer 7 can also be an integral part of the top part 5. The spacer creates a distance between the top part and the membrane 8 so that the fluid can flow radially out to the first openings 12.

The pin-hole plate 9 can have a circumferential wall 15 surrounding a bottom surface 16 with the hole 14 in the centre. The membrane is held in place by the spacer and the pin-hole plate. Once assembled, the valve features a small gap below the membrane, which will be defined by the height of the circumferential wall. The gap is typically of a similar size as the thickness of the membrane, e.g. half the thickness of the membrane as indicated in FIG. 5. The fluid flow is indicated by the arrows. Once the fluid passes the fluid inlet and reaches the membrane, it is forced predominantly radially outwards and through the first openings situated in the spacer. These first openings constitute the bypass channel. On the lower side of the membrane, the fluid will (provided the valve is open) enter the hole 14 in the centre of the pin-hole plate and finally exit through the fluid outlet 4 in the base part.

FIG. 1B shows a schematic cross-section of a valve according to the present disclosure in order to illustrate the different material parameters associated with the valve and the fluid flow through the valve. By changing the dimensions of the pin-hole plate 9, the parameters Band h₀ may be customized and pre-determined in order to achieve a particular flow-characteristic of the valve. The parameter d is the diameter of the hole 14 in the pin-hole plate and the parameter h₀ is the distance between the membrane 8 and the bottom surface 16 of the pin-hole plate or expressed in another way the height of the circumferential wall 15. When the pressure difference, Δp, over the valve 1 increases, the pressure acting on the membrane 8 will increase so that the membrane deflects until the centre of the membrane touches the bottom surface 16 of the pin-hole plate 9. By positioning the hole 14, where the membrane 8 touches the bottom surface, the hole will be blocked so that fluid passing through the second openings 13 cannot enter the hole and leave the valve through the fluid outlet 4. That the hole has a diameter, d, does not necessarily mean that the hole is round; the hole can have any shape even though a round hole is preferable, since a round hole can easily be manufactured to a high degree of accuracy by drilling. That the hole has a diameter, d, if the hole is not round, means that the opening area of the not-round hole corresponds to the opening area of a round hole with diameter, d.

The pin-hole plate is easily replaceable, so that by choosing another pin-hole plate with other parameters d and h₀, a valve can be achieved with a certain other desired flow-rate versus pressure-drop characteristic without changing anything else in the valve assembly but the pin-hole plate. The valve assembly of the present disclosure can be adapted easily and fast to a wide-selection of flow-rate versus pressure-drop characteristics at a very low cost. The diameter of the hole 14 in the pin-hole plate (parameter d) and the height of the circumferential wall 15 (parameter h₀) can be manufactured fast at a very high degree of accuracy and at a low cost e.g. by drilling and milling. For that reason, the parameters d and h₀ are good choices for controlling the fluid flow characteristics of the valve.

The bottom surface 16 may have a recess or groove around and close to the hole 14 for receiving an O-ring (not shown). If the O-ring protrudes above the bottom surface 16, the valve will close for fluid flow at a lower pressure difference over the valve, since the membrane will get in contact with the O-ring at a lower pressure difference over the valve than with the bottom surface without the O-ring. Therefore, using the same pin-hole plate, the parameter h₀ can still be varied by changing the thickness of the O-ring, since with an O-ring the parameter h₀ is the distance between the membrane, when no pressure is acting on the membrane, and the O-ring.

FIG. 1C shows the non-linear flow-rate versus pressure-drop characteristic of a valve according to the present disclosure. As evident from the graph, the flow rate increases approximately linearly for small values of the pressure drop. However, as the pressure drop increases, the fluid resistance increases as well. At a certain pressure, determined by the geometry and the material parameters of the valve, the flow rate reaches a maximum. Beyond this maximum, the flow rate decreases with increasing pressure drop and eventually the flow rate reaches zero, i.e. the valve is closed. The data (grey dots) is from an experiment of a valve according to the present disclosure, wherein the pressure drop across the valve was varied between 0-0.4 bars and the flow rate, Q, was measured. The solid curve is a fitted curve to the data.

In FIG. 1D an alternative valve 1′ is shown. The alternative valve 1′ is identical to the valve 1 shown in FIG. 1b except for s support 17. The support is preferably attached to the top part 5, and the membrane 8 can freely move downward away from the support 17 without interference from the support. The support will support the membrane 8 so that the membrane does not break, if the fluid outlet 4 is accidentally connected to the pump (not shown). The support will have openings (not shown) so that the fluid from the fluid inlet can flow to and through the second openings 13 of the membrane.

In another embodiment (not shown), the valve may comprise a first and a second pin-hole plates positioned on each side of the membrane, where the first and second pin-hole plates act in opposite directions, so that the first pin-hole plate determines the flow-rate versus pressure-drop characteristic of the valve when the fluid enters the valve from one direction, while the second pin-hole plate determines the flow-rate versus pressure-drop characteristic of the valve when the fluid enters the valve from the opposite direction. By turning the valve around the valve can show a totally different flow-rate versus pressure-drop characteristic.

FIG. 2A shows a schematic of a valve assembly comprising two leaky check-valves connected in parallel. The two valves experience the same pressure drop, but the volumetric flow rate (the volume of fluid per unit time) through the valve depends on the characteristics of the valve.

FIG. 2B shows the flow-rate versus pressure-drop relation for each valve and for the parallel valve assembly of FIG. 2A (here denoted a valves network). The solid line represent the relation for the valve assembly, and the two dashed lines each represent a valve from the assembly of FIG. 2A. The resulting flow-rate versus pressure-drop characteristic for the valve assembly is a superposition of the individual valves that constitute the assembly.

FIG. 2C shows how to approximate an objective flow-rate versus pressure-drop characteristic using the presently described valve assembly and method. In this example, the objective function (dark-grey, wide dashed line) is Q=1, which means that the flow rate should be constant (arbitrary units). The solid black line shows the output characteristic of a network using four valves. Notice that the outputted flow rate of the valve network mimics the objective function to a good approximation, even though only four valves are used. The four valves each displayed different peak pressure and closing pressure (the light-grey, thin dashed lines). In case more valves are used, an even better approximation to the objective function can be achieved.

FIG. 2D shows another example of approximating an objective flow-rate versus pressure-drop characteristic. This example is analogous to that of FIG. 2C except that the objective function (dark-grey, wide dashed line) is more complex. Four valves are still used, but they have a different design, displaying different valve characteristics (light-grey, thin dashed lines) than that of FIG. 2C in order to mimic the given objective function. Similar to FIG. 2C, the output characteristic of the valve network (solid black line) comprising the four valves is a good approximation to the desired characteristic (objective function).

FIG. 3 shows schematically an embodiment of the computer-implemented method to determine the optimal arrangement of passive check valves to achieve arbitrary flow control. The first step of the algorithm is to provide an objective flow-rate versus pressure-drop function as input. Next, the valve assembly is customized using an optimization method, wherein the material parameters of each valve is tuned such that the characteristic of the valve assembly approximates the objective function. The algorithm then outputs the minimum number of valves required and/or the material parameters of each valve. Alternatively, the number of valves is given as input to the algorithm, and the algorithm subsequently determines the valve material parameters and the optimal arrangement of the valves. Material parameters of the valve can include the stiffness of the flexible element (e.g. the thickness and/or area of a membrane), the diameter of the outlet (d) of the pin-hole plate, the height under the flexible element (h₀) and other parameters. These parameters determine the characteristic of the valve, i.e. the flow-rate versus pressure-drop function of the valve. By combining a number of valves with different characteristics, it is possible to tune the overall characteristic of the valve assembly such that it mimics the objective flow-rate versus pressure-drop function.

FIG. 4 shows a 3D illustration of an embodiment of a non-linear check valve according to the present disclosure. The illustration shows a cross-section of the device, such that parts of the interior of the device are visible. This particular embodiment features two horizontal channels 10 that need to be connected, e.g. via a flexible tube, in order to constitute the bypass channel 10. The gap below the membrane 8 is hardly visible because of the small dimension compared to the height of the inlet chamber 11.

FIG. 5 shows a schematic diagram of the working principle of the device (a leaky check-valve with a non-linear flow-rate versus pressure-drop characteristic). The flow of the fluid through the device is indicated with arrows. The device comprises a fluid (inlet) channel 3 through which a fluid is introduced. The fluid then enters a bypass channel 10, since this is the only passageway in fluid connection with the outlet 4 of the device. The fluid is then directed through a small channel and led out of the device via a fluid outlet 4. The device further features a flexible element (here a membrane 8 with a thickness of 400 μm as an example), preferably a flexible membrane. The small channel or gap below the flexible element is here shown to have a height of 200 μm as an example. As the pressure increases, the membrane deflects downwards and increasingly narrows the height under the membrane, such that the valve ultimately closes. This figure is not to scale.

FIG. 6A shows the working principle of the leaky check-valve according to the present disclosure. The figure illustrates the gradual closure of the valve for increasing pressures. The pressure on the membrane is indicated by small arrows on top of the membrane, and the fluid flow through the valve is indicated by longer arrows. The figure shows three states of the valve: Two wherein the valve is open and one wherein the valve is closed. In the first state, there is a low pressure drop across the valve, resulting in a very small (or zero) deformation of the membrane. The valve is open and the flow rate is low. In the second state, there is a higher, optimal pressure drop, wherein the flow-rate corresponds to the maximum of that particular valve. The membrane deflects downwards and narrows the gap below the membrane. The valve is open and the flow rate is high. In the third state, the pressure-drop is high enough that the membrane closes the fluid outlet such that there is zero flow through the device, i.e. the valve is closed.

FIG. 6B shows some relevant design parameters of the leaky check-valve. The membrane 8 has a thickness t and a radius R, the height below the membrane is denoted h₀, and the radius of the fluid outlet 4 is denoted r. The valve characteristic (i.e. the flow-rate versus pressure-drop relation) can be tuned by varying these material parameters. The thickness of the membrane may typically be approximately 15 μm up to several millimetres, e.g. 1-3 mm. The height, h₀, below the membrane may then be approximately 10 μm to approximately 200 μm. However, the membrane may be manufactured to be even thinner, e.g. using microfluidic fabrication techniques, such that the membrane 8 has a thickness of approximately 0.1 μm to 15 μm. In case the membrane thickness is within this interval, the height, h₀, below the membrane will be approximately 0.05 μm to approximately 10 μm, i.e. significantly smaller than the aforementioned values.

FIG. 6C shows experimental data of a pressure-sensitive leaky check-valve, wherein the flow-rate through the valve was recorded for various pressure drops. The solid curve is a fitted curve to the data. It is seen that the valve displays a non-linear flow-rate versus pressure-drop characteristic, which features a certain maximum (peak) flow-rate for a given pressure drop. Furthermore, the valve closes at a certain pressure, here that particular pressure is seen to be approximately 2700 Pa. This particular valve has the following material parameters: h₀=160 μm, R=9 mm, r=3 mm, and t=1 mm. The closing pressure of the valve may be adjusted by choosing different values of the material parameters. Accordingly, the closing pressure of the valve is pre-determined based on the choice of the material parameters.

FIG. 7A shows a schematic of a valve assembly comprising three check-valves according to one embodiment of the present disclosure. The three valves are connected in parallel. FIGS. 7A, 7B, and 7C illustrate three states of the valve assembly that corresponds to various pressure drops across the valve assembly. FIG. 7D illustrates the flow-rate versus pressure-drop relation for the valve assembly (solid curve). The dashed curves represent the flow-rate versus pressure-drop relation of the individual valves when isolated from the valve assembly. The flow rate and pressures are normalized, i.e. they are dimensionless, since it is the working principle that is intended to be shown by the graph. For small pressure-drops, all three valves are open, FIG. 7A. In this example, as the pressure increases, one of the valves closes while the other two remain open, FIG. 7B. For even higher pressures, two of the valves are closed and only one remains open, FIG. 7C.

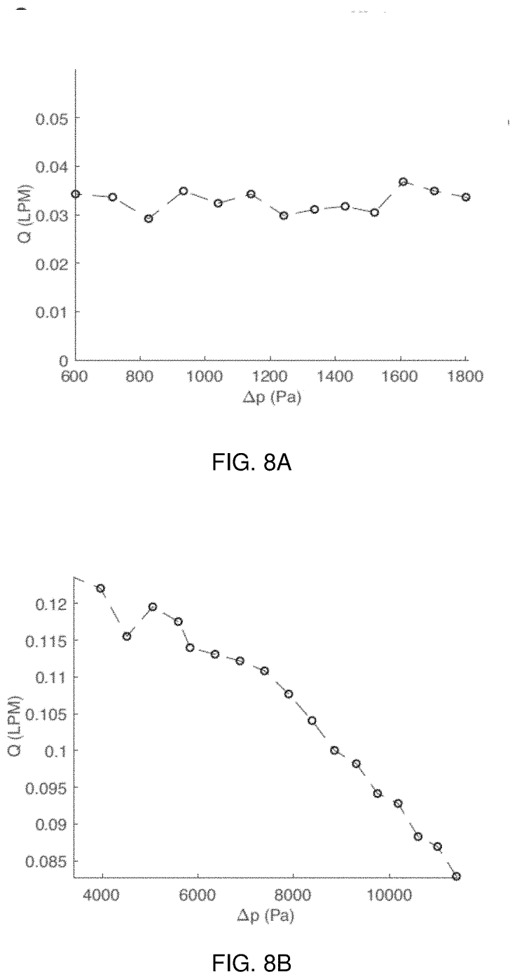

FIG. 8A shows experimental data from a valve assembly mimicking an objective function. In this example, the objective flow-rate versus pressure-drop relation is constant. The flow through the valve assembly is seen to be approximately constant on a range of pressures (˜600-1800 Pa).

FIG. 8B shows experimental data from a valve assembly mimicking another objective function, different from the function of FIG. 8A. In this example, the objective was to create a ‘reversed Ohm's law’ for fluids, i.e. wherein the flow-rate decreases linearly with increasing pressure. As evident from the graph, the flow-rate through the valve assembly decreases approximately linear with increasing pressure-drop across the device on a range of pressures (˜3000-12000 Pa).

FIG. 9A shows two check valves according to the present disclosure. These valves are made using a standard filter holder and correspond to the valve schematically shown in FIG. 1A. The valves can be disassembled by unscrewing the base part 6 and the top part 5 from each other.

FIG. 9B shows the base part 6 of a valve comprising a membrane 8. The second openings 13 at the rim of the membrane 8 constitute the bypass channels.

FIG. 9C shows the base part 6 of a valve assembly 2 according to the present disclosure, the valve assembly comprising three check valves 1 (outlined with dashed curves) sharing a common membrane 8. The three valves each comprise five second openings 13 that constitute bypass channels. The image also shows a transparent spacer 7, or intermediate section, which is placed on top of the membrane. The spacer features a number of first openings 12. It is seen that the first openings of the spacer align with the second openings in the membrane such that they form bypass channels. Therefore, the reference numbers 12 and 13 point to the same openings but at different altitudes. The spacer further features a central opening for each valve, which constitute the fluid inlet 3.

FIG. 10A shows yet another embodiment of a valve assembly according to the present disclosure. This valve assembly comprises four leaky check-valves 1. While the four valves share the same membrane 8, the deflection of each sub-membrane does not influence the performance of the other valves in the valve assembly. In this example, the membrane thickness is identical for each valve in the valve assembly. However, by varying the surface area of the membrane and the gap below the membrane for each valve, each valve can be tailor-made to display a certain characteristic. FIG. 10A only displays the inner part of the final device, i.e. without the base part and the top part. However, FIG. 10B shows the final device when it is assembled.

FIG. 10B shows a picture of a valve assembly 2 that has been assembled with its base part 6 and top part 5, such that the final valve assembly only features one fluid inlet 3 and one fluid outlet (the latter not visible in this picture). Accordingly, the plurality of valves are enclosed in a common housing comprising a fluid inlet and a fluid outlet.

FIG. 10C shows the inner parts (the pin-hole plate 9 underneath the membrane 8 underneath the spacer 7) next to the housing (base part 6 plus top part 5) of the final valve assembly 2.

FIGS. 11 shows valve assemblies of different types of configurations. The valves can arranged in series as shown in FIG. 11A or in parallel as shown in FIG. 11B. The number of valves in each of these configurations is indefinite. The valves can also be arranged in a combination of serial and parallel connections as shown in FIG. 11C, which is called a network. FIG. 11C shows one such combination. The number of combinations is of course indefinite.

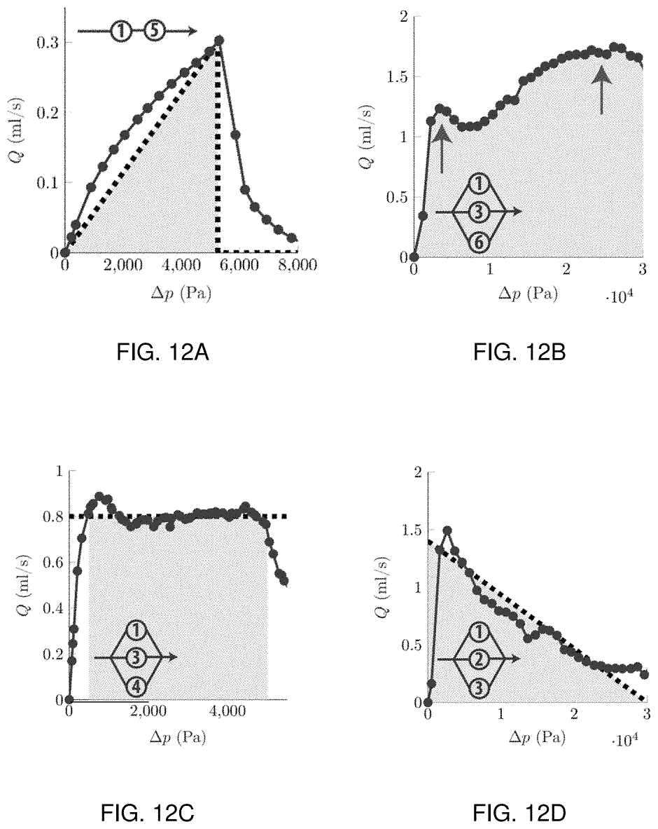

FIGS. 12A-D show diagrams of the flow-rate versus pressure-drop for different valve assemblies comprising two or three of a selection of six valves. The six valves are presented in Table 1.

TABLE 1
Properties of valves 1-6 used in the valve
assemblies presented in FIGS. 12A-D

| Valve id. | D [mm] | d [mm] | h0 [mm] | t [mm] | E [MPa] |
|---|---|---|---|---|---|
| 1 | 7.91 | 2.63 | 0.17 | 1.1 | 0.88 |
| 2 | 5.50 | 1.83 | 0.08 | 2.0 | 1.12 |
| 3 | 5.50 | 1.10 | 0.08 | 1.1 | 0.88 |
| 4 | 4.53 | 0.91 | 0.11 | 1.1 | 0.88 |
| 5 | 4.53 | 0.65 | 0.11 | 1.0 | 1.12 |
| 6 | 4.53 | 0.91 | 0.11 | 1.4 | 1.12 |

Table 1 discloses the parameters D, d, h₀, t, and E for the six valves. FIG. 1B show to which physical quantities the parameters D, d, h₀, and t correspond. The parameter E is the elastic modulus of the membrane.

FIG. 12A shows an objective function of the flow-rate versus pressure-drop relation, where the flow rate increases linearly as a function of the pressure difference over the valve assembly up to a certain pressure difference, above which the valve assembly is blocked. By connecting only two valves, valve 1 and valve 5 in series, we receive a valve assembly that is mimicking objective function quite well.

FIG. 12B shows the flow-rate versus pressure-drop relation when valves 1, 3, and 6 are connected in parallel. The diagram shows two peaks marked with arrows at around 3.500 kPa and 25 kPa. By replacing valve 6 by valve 4 we get the flow-rate versus pressure-drop relation shown in FIG. 12C, which presents a nearly constant fluid flow irrespective of the pressure-drop between 500 Pa and 5000 Pa.

By replacing valve 4 in the valve assembly of FIG. 12C by valve 2 we receive a flow-rate versus pressure-drop relation a reverse Ohm flow, i.e. the fluid flow Q=Q₀−CΔp,

corresponding to an approximately constant negative hydraulic resistance.

In the examples presented in FIG. 12A-D, it is shown how profoundly the flow-rate versus pressure-drop relation can be varied by just changing one valve in a valve assembly. In the examples presented in FIG. 12A-D, five different parameters D, d, h₀, t, and E were varied. However, in principle the variations in the flow-rate versus pressure-drop relation could be achieved by only varying the parameters Band h₀ of the pin-hole plate.

FIG. 13 shows how a suitably designed valve assembly according to the present disclosure eliminates the variation in flow rate from a pump, in this example a peristaltic pump, so that flow rate is constant. In this example, the fluid pumped by the pump is water that is pumped into a container positioned on top of a balance. In FIG. 13, the weight acting on the balance is shown versus time with (solid line) and without (dashed line) the valve assembly connected between the pump and the outlet into the container. Since the container is slowly filled up, the balance will show how the mass in the container increases. The slopes of the graphs are the flow rates. Without the valve assembly the flow rate varies periodically with the period of the wheel in the peristaltic pump pressing the fluid forward. The dashed line seem to indicate that the water pumped into the container periodically decreases. The decrease is not due to water leaving the container but due to the balance swinging back when there is no or very little water poured into the container just after much water has been poured into the container. The solid line shows that the valve assembly evens out the flow rate from the very simple and cost-effective peristaltic pump so that the periodic variation is hardly detectable.

### EXAMPLES

Two examples about how to customize a valve assembly are disclosed. The key objective in flow regulation processes can be to control the output flow rate as function of the input pressure Δp. Given a desired target pressure-flow characteristic Qₜ, we can seek the combination of valves that most closely resemble Qₜ.

Consider a parallel coupling of N different valves. The total flow rate is

Q=Σₙ₌₁^{N}Qₙ, (1)

where the flow across each individual valve

$${Q}_{n} = {C}_{n} Δ {p ( 1 - \frac{Δ p}{{σ}_{n}} )}^{k} \qquad ( 2 )$$

can be characterized by the amplitude Cₙ and closing pressure σₙ. The optimal choice of the valve parameters can correspond to minimizing the mean square difference

I=∫ₚ_{ₐ}^{p}^{_{b}}(Qₜ−Σₙ₌₁^{N}Qₙ)²d(Δp) (3)

where pₐ and p_{b} delimits the pressure interval of interest.

The eq. (3) can be minimised in at least two ways. In a first example to minimize I the valves can be assumed to have a fixed set of closing pressure σ_{n (n=1 . . . N)}, and we can seek to determine the amplitudes Cₙ. The flow rate across the n′th valve can be written as Qₙ=Cₙqₙ, where qₙ=Δp(1−Δp/σₙ)^{k}, which leads to

I=∫ₚ_{ₐ}^{p}^{_{b}}(Qₜ−Σₙ₌₁^{N}Cₙqₙ)²d(Δp). (4)

Following the standard procedure used in e.g. Fourier series, we can take the derivative with respect to Cₘ in Eq. (4). This leads to a linear equation system for the valve parameters Cₙ which can be readily solved using linear algebra:

a. Σₙ₌₁^{N}CₙAₙₘ−Bₘ=0, for m=1, 2, . . . , N (5)

where the matrix elements are

Aₙₘ=∫ₚ_{ₐ}^{p}^{_{b}}qₘqₙd(Δp)and Bₘ=∫ₚ_{ₐ}^{p}^{_{b}}qₘQₜd(Δp). (6)

We can minimize Eq. (4) using a fixed set of valve parameters σ_{n (n=1 . . . N)} that are, for instance, equally spaced, which provides a relatively close approximation to many target functions.

In an alternative approach, we can use a numerical method to mitigate the limitations to the analytical approach outlined above. Using simulated annealing, we allowed both Cₙ and σₙ to vary in the optimization process, while constraining the parameter values to Cₙ>0 and σₙ>0. Note that for a fixed number of valves N, the two methods provided similar values of the optimization measure I in the majority of cases.

### Further Details of the Invention

1. A valve assembly comprising at least two pressure-sensitive passive check valves connected in series or parallel, wherein each of said valves closes at a certain pre-determined pressure, wherein the valve assembly is capable of providing a given objective flow-rate versus pressure-drop characteristic.
2. The valve assembly according to item 1, wherein each valve of the valve assembly features a pre-determined non-linear flow-rate versus pressure-drop characteristic.
3. The valve assembly according to any of the preceding items, wherein the valve assembly is capable of providing a given objective flow-rate versus pressure-drop characteristic determined by the individual valve characteristics.
4. The valve assembly according to any of the preceding items, wherein the valve assembly is an integrated valve assembly.
5. The valve assembly according to any of the preceding items, wherein the valve assembly comprises at least three pressure-sensitive passive check valves connected in series, in parallel or in a network.
6. The valve assembly according to any of the preceding items, wherein each valve is a leaky check valve.
7. The valve assembly according to any of the preceding items, wherein each valve is completely mechanical, such that the flow control is achieved solely from fluid-structure interactions.
8. The valve assembly according to any of the preceding items, wherein at least one of the valves in the valve assembly has a flow-rate versus pressure-drop relation displaying a peak flow-rate on the range of working pressures.
9. The valve assembly according to item 8, wherein at least one of the valves in the valve assembly has a flow-rate versus pressure-drop relation, wherein the flow-rate decreases with increasing pressure beyond said peak flow-rate.
10. The valve assembly according to any of the preceding items, wherein each valve comprises a replaceable pin-hole plate for receiving a membrane.
11. The valve assembly according to item 10, wherein the replaceable pin-hole plate comprises a wall and a bottom surface with a hole, wherein the wall has a certain height (h₀) in relation the bottom surface.
12. The valve assembly according to item 11, wherein the position of the hole is configured to be where the membrane touches the bottom surface when the pressure difference over the valve increases.
13. The valve assembly according to any of item 11 or 12, wherein an O-ring surrounds the hole, and wherein the height, h₀, is the height difference between the top of the wall and the top of the O-ring.
14. The valve assembly according to any of the preceding items, wherein each valve comprises a spacer for securing a membrane to the valve.
15. The valve assembly according to any of the preceding items, wherein each valve comprises at least one bypass channel.
16. The valve assembly according to any of the preceding items, wherein each valve comprises a flexible membrane.
17. The valve assembly according to any of the preceding items, wherein each valve comprises a top part comprising a fluid inlet, a spacer comprising at least one bypass channel or one or more first openings, a membrane with possibly one or more second openings, a pin-hole plate, and a base part comprising a fluid outlet.
18. The valve assembly according to any of the preceding items, wherein the membrane is approximately 0.05 mm to approximately 1 mm in thickness.
19. The valve assembly according to any of the preceding items, wherein the height below the membrane is approximately 0.01 mm to approximately 0.1 mm.
20. The valve assembly according to any of the preceding items, wherein each valve has a maximum working pressure of approximately 0.1 bar to approximately 10 bar.
21. The valve assembly according to any of the preceding items, wherein the valve assembly is formed by integrating multiple valves in a common membrane.
22. The valve assembly according to any of the preceding items, wherein the plurality of valves are enclosed in a common housing comprising one fluid inlet and one fluid outlet.
23. The valve assembly according to item 22, wherein the housing comprises a lid and a base part, which are detachable, such that the housing may be disassembled.
24. The valve assembly according to any of the preceding items, wherein the valves and/or the valve assembly are manufactured using additive manufacturing, e.g. 3D printing.
25. The valve assembly according to any of the preceding items, wherein at least one of the at least two valves has an intended flow direction, wherein the valve comprises a support positioned upstream and next to a membrane, wherein the support is configured for preventing the membrane from breaking if the fluid flows in the direction opposite to the intended direction.
26. The valve assembly according to any of the preceding claims, wherein at least one of the at least two valves comprises a first pin-hole plate with a first hole and a second pin-hole plate with a second hole, wherein the first and the second pin-hole plates are positioned on opposite sides of the membrane, wherein the membrane is configured for blocking fluid flow through the first hole when the fluid flows in one direction and for blocking fluid flow through the second hole when the fluid flows in the opposite direction.
27. A computer-implemented method for customizing the valve assembly according to any of the items 1-26, the method comprising the steps of:
   a. providing an objective flow rate versus pressure-drop function;
   b. optimizing the valve assembly under a given constraint in order to approximate the objective function;
   c. outputting the minimum number of valves required, and/or the material parameters of each valve, and/or the deviation from the objective function.
28. The method according to item 27, wherein the constraint is selected among the group of: number of valves, material parameters, and deviation from the objective function.
29. The method according to item 27, wherein the objective flow rate versus pressure-drop function is approximated by the valve assembly to a given pre-determined precision.
30. The method according to any of the preceding items 27-29, wherein the valve assembly is optimized using a fixed number of valves, wherein the characteristic of each valve is tuned by tuning the material parameters and/or the geometry of each valve.

### REFERENCE NUMERALS

1. Valve
2. Valve assembly
3. Fluid inlet
4. Fluid outlet
5. Top part
6. Base part
7. Spacer
8. Membrane
9. Pin-hole plate
10. Bypass channel
11. Inlet chamber
12. First openings
13. Second openings
14. Hole
15. Circumferential wall
16. Bottom surface
17. Support

1. A valve assembly for controlling fluid flow, the valve assembly comprising at least two pressure-sensitive passive check valves, wherein each of said valves closes at a pre-determined pressure, and wherein the flow-rate versus pressure-drop characteristic of the valve assembly is a superposition of the individual valve characteristics.

2. The valve assembly according to claim 1, wherein each valve of the valve assembly features a pre-determined non-linear flow-rate versus pressure-drop characteristic.

3. The valve assembly according to claim 1, wherein the valve assembly is capable of providing a given objective flow-rate versus pressure-drop characteristic determined by the individual valve characteristics.

4. The valve assembly according to claim 1, wherein the valve assembly is an integrated valve assembly.

5. The valve assembly according to claim 1, wherein the valves of the valve assembly are integrated in a single membrane.

6. The valve assembly according to claim 1, wherein the plurality of valves are enclosed in a common housing comprising one fluid inlet and one fluid outlet.

7. The valve assembly according to claim 6, wherein the housing comprises a lid and a base part, which are detachable, such that the housing may be disassembled.

8. The valve assembly according to claim 1, wherein the flow control is achieved solely from fluid-structure interactions in the valve assembly.

9. The valve assembly according to claim 1, wherein at least one of the valves in the valve assembly has a flow-rate versus pressure-drop relation displaying a peak flow-rate on the range of working pressures.

10. The valve assembly according to claim 9, wherein at least one of the valves in the valve assembly has a flow-rate versus pressure-drop relation, wherein the flow-rate decreases with increasing pressure beyond said peak flow-rate.

11. The valve assembly according to claim 1, wherein the valve assembly comprises a replaceable pin-hole plate for receiving a membrane.

12. The valve assembly according to claim 11, wherein the replaceable pin-hole plate comprises a wall and a bottom surface with a hole, wherein the wall has a certain height (h₀) in relation the bottom surface.

13. The valve assembly according to claim 12, wherein the position of the hole is configured to be where the membrane touches the bottom surface when the pressure difference over the valve increases.

14. The valve assembly according to claim 12, wherein an O-ring surrounds the hole, and wherein the height, h₀, is the height difference between the top of the wall and the top of the O-ring.

15. The valve assembly according to claim 1, wherein the valve assembly comprises a spacer for securing a membrane to the valve.

16. The valve assembly according to claim 1, wherein each valve comprises at least one bypass channel.

17. The valve assembly according to claim 1, wherein each valve comprises a flexible membrane.

18. The valve assembly according to claim 1, wherein at least one of the at least two valves has an intended flow direction, wherein the valve comprises a support positioned upstream and next to a membrane, wherein the support is configured for preventing the membrane from breaking if the fluid flows in the direction opposite to the intended direction.

19. The valve assembly according to claim 1, wherein at least one of the at least two valves comprises a first pin-hole plate with a first hole and a second pin-hole plate with a second hole, wherein the first and the second pin-hole plates are positioned on opposite sides of the membrane, wherein the membrane is configured for blocking fluid flow through the first hole when the fluid flows in one direction and for blocking fluid flow through the second hole when the fluid flows in the opposite direction.

20. A computer-implemented method for customizing a valve assembly comprising at least two pressure-sensitive passive check valves, wherein each of said valves closes at a pre-determined pressure, the method comprising the steps of:
a. providing an objective flow rate versus pressure-drop function;
b. optimizing the valve assembly under a given constraint in order to approximate the objective function;
c. outputting the minimum number of valves required, and/or the material parameters of each valve, and/or the deviation from the objective function.

21. The method according to claim 20, wherein the constraint is selected among the group of: number of valves, material parameters, and deviation from the objective function.

22. The method according to claim 20, wherein the valve assembly is optimized using a fixed number of valves, wherein the characteristic of each valve is tuned by varying the material parameters and/or the geometry of each valve.
